(19) United States
(12) Patent Application Publication
(10) Pub. No.: US 2009/0315873 A1
(43) Pub. Date: Dec. 24, 2009

(54) ENERGY RECOVERY CIRCUIT AND PLASMA DISPLAY APPARATUS THEREOF

(75) Inventor: Jeong Pil CHOI, Seoul (KR)

Correspondence Address: KED & ASSOCIATES, LLP, P.O. Box 221200, Chantilly, VA, 20153-1200, US

(73) Assignee: LG Electronics Inc

(21) Appl. No.: 12/549,736

(22) Filed: Aug. 28, 2009

Related U.S. Application Data
(63) Continuation of application No. 11/931,247, filed on Oct. 31, 2007.

(30) Foreign Application Priority Data
Oct. 17, 2007 (KR) 10-2007-0104669

(51) Int. Cl. G06F 3/038

(52) U.S. Cl. 345/211; 345/60

(57) ABSTRACT

The present invention relates to an energy recovery circuit for supplying driving signals to a plasma display panel (PDP), and a plasma display apparatus employing the same. The plasma display apparatus includes a PDP, and a driver for generating a driving signal for driving the PDP. The driver includes a first capacitor that charges a voltage recovered from the PDP, an inductor that forms a resonant circuit together with the first capacitor, a voltage source that supplies a voltage for generating the driving signal, and a second capacitor connected between one end of the inductor and a voltage source. According to the present invention, in the event that a driving signal is to be supplied to a PDP using an energy recovery circuit, a capacitor is connected to one end of the inductor of the energy recovery circuit. Accordingly, distortion of a driving signal waveform supplied to a panel, which is caused by using a cheap element, can be prevented, damage to an inductor due to a voltage can be prevented, and stability of the energy recovery circuit can be improved.

### CROSS-REFERENCE TO RELATED APPLICATIONS

This application is a Continuation Application of prior U.S. patent application Ser. No. 11/931,247 filed Oct. 31, 2007, which claims priority under 35 U.S.C. §119 to Korean Application No. 10-2007-0104669 filed on Oct. 17, 2007, whose entire disclosures are hereby incorporated by reference.

### BACKGROUND

1. Field

The present invention relates to a plasma display apparatus, and more particularly, to an energy recovery circuit for supplying driving signals to a plasma display panel (hereinafter, referred to as a “PDP”).

2. Background

A PDP is adapted to display images by exciting phosphors with vacuum ultraviolet rays (VUV) generated when an inert mixed gas is discharged.

The PDP has advantages that it can be easily made large and thin and can be simply fabricated due to a simple structure, and has higher luminance and emission efficiency than other flat display devices. In particular, an alternating current (AC) surface discharge type three-electrode PDP is advantageous in that it has lower voltage driving and longer lifespan because wall charges are accumulated on a surface upon discharge and protect electrodes from sputtering generated by a discharge.

The PDP is driven with it being time-divided into a reset period for resetting the entire cells, an address period for selecting a cell, and a sustain period for generating a display discharge in a selected cell in order to implement gray levels of an image.

In order for a driving circuit to supply driving signals to a PDP, a plurality of switching elements and clamping diodes are required. Thus, there are problems in a rising cost due to an increased number of components and an increased size. There is also a problem in that consumption power of a panel driving circuit increases due to the increased components.

### SUMMARY OF THE INVENTION

In order to solve the above problems, a technical object of the present invention is to provide a plasma display apparatus equipped with a driving circuit with high reliability, which can reduce the manufacturing cost and the occurrence of electromagnetic waves and also increase energy efficiency, in an energy recovery circuit included in the plasma display apparatus.

A plasma display apparatus according to the present invention includes a PDP, and a driver for generating a driving signal for driving the PDP. The driver includes a first capacitor that charges a voltage recovered from the PDP, an inductor that forms a resonant circuit together with the first capacitor, a voltage source that supplies a voltage for generating the driving signal, and a second capacitor connected between one end of the inductor and a voltage source.

An energy recovery circuit according to the present invention includes a first capacitor for charging a voltage recovered from the PDP, an inductor forming a resonant circuit together with the first capacitor, a sustain voltage source, a reference voltage source, a second capacitor connected to one end of both ends of the inductor, which is not connected to the PDP, and the sustain voltage source, and a third capacitor connected between the one end of the inductor and the reference voltage source.

### BRIEF DESCRIPTION OF THE DRAWINGS

FIG. 1 is a perspective view illustrating an embodiment of a structure of a PDP;

FIG. 2 is a sectional view illustrating an embodiment of electrode arrangements of the PDP;

FIG. 3 is a timing diagram illustrating an embodiment of a method of time-dividing and driving the PDP by dividing one frame into a plurality of subfields;

FIG. 4 is a timing diagram illustrating an embodiment of driving signals for driving the PDP;

FIG. 5 is a circuit diagram illustrating a construction of an energy recovery circuit for supplying a sustain signal to scan electrodes or sustain electrodes of the PDP;

FIGS. 6 and 7 are graphs illustrating embodiments of waveforms of the sustain signal supplied to the PDP; and

FIGS. 8 to 14 are circuit diagrams illustrating embodiments of a construction of the energy recovery circuit according to the present invention.

### DETAILED DESCRIPTION

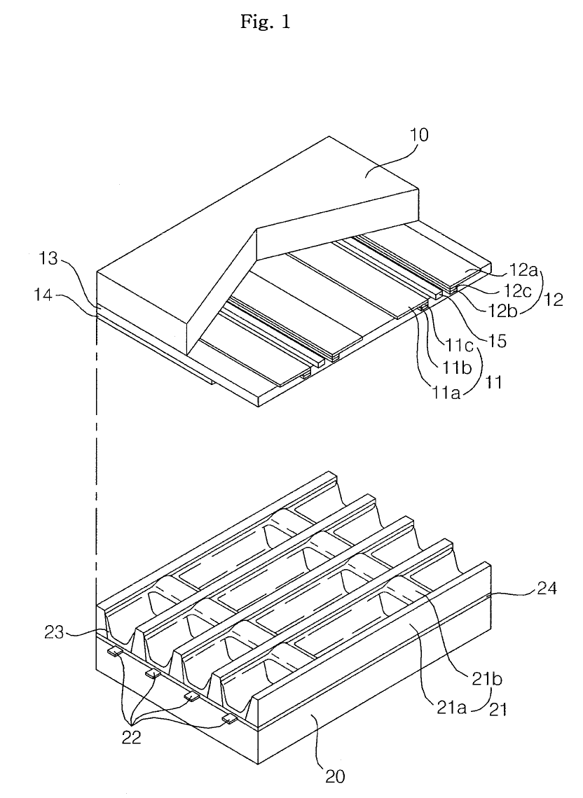

An energy recovery circuit and a plasma display apparatus employing the same according to the present invention will now be described in detail with reference to the accompanying drawings. FIG. 1 is a perspective view illustrating an embodiment of a structure of a PDP.

Referring to FIG. 1, the PDP includes a scan electrode 11 and a sustain electrode 12 (that is, a sustain electrode pair), which are formed over a front substrate 10, and address electrodes 22 formed over a rear substrate 20.

The sustain electrode pair 11 and 12 includes transparent electrodes 11a and 12a generally formed from indium-tin-oxide (ITO), and bus electrodes 11b and 12b. The bus electrodes 11b and 12b may be formed from metal, such as silver (Ag) or chrome (Cr), a stack type of Cr/copper (Cu)/Cr or Cr/aluminum (Al)/Cr. The bus electrodes 11b and 12b are formed on the transparent electrodes 11a and 12a, and function to decrease a voltage drop caused by the transparent electrodes 11a and 12a with a high resistance.

In accordance with an embodiment of the present invention, the sustain electrode pair 11 and 12 may have a stack structure of the transparent electrodes 11a and 12a and the bus electrodes 11b and 12b, but also include only the bus electrodes 11b and 12b without the transparent electrodes 11a and 12a. This structure is advantageous in that it can save the manufacturing cost of the PDP because the transparent electrodes 11a and 12a are not used. The bus electrodes 11b and 12b used in the structure may also be formed using a variety of materials, such as a photosensitive material, other than the above-listed materials.

Black matrices 15 are arranged between the transparent electrodes 11a and 12a and the bus electrodes 11b and 12b of the scan electrode 11 and the sustain electrode 12. The black matrix 15 has a light-shielding function of absorbing external light generated outside the front substrate 10 and decreasing reflection of the light and a function of improving the purity and contrast of the front substrate 10.

The black matrices 15 in accordance with an embodiment of the present invention are formed over the front substrate 10. Each black matrix 15 may include a first black matrix 15 formed at a location where it is overlapped with a barrier rib 21, and second black matrices 11c and 12c formed between the transparent electrodes 11a and 12a and the bus electrodes 11b and 12b. The first black matrix 15, and the second black matrices 11c and 12c, which are also referred to as black layers or black electrode layers, may be formed at the same time and, therefore, may be connected physically. Alternatively, they may not be formed at the same time and, therefore, may not be connected physically.

In the event that the first black matrix 15 and the second black matrices 11c and 12c are connected to each other physically, the first black matrix 15 and the second black matrices 11c and 12c are formed using the same material. However, in the event that the first black matrix 15 and the second black matrices 11c and 12c are physically separated from each other, they may be formed using different materials.

An upper dielectric layer 13 and a protection layer 14 are laminated over the front substrate 10 in which the scan electrodes 11 and the sustain electrodes 12 are formed in parallel. Charged particles generated by a discharge are accumulated on the upper dielectric layer 13. The upper dielectric layer 13 and the protection layer 14 may function to protect the sustain electrode pair 11 and 12. The protection layer 14 functions to protect the upper dielectric layer 13 from sputtering of charged particles generated at the time of a gas discharge and also increase emission efficiency of secondary electrons.

The address electrodes 22 cross the scan electrodes 11 and the sustain electrodes 12. A lower dielectric layer 24 and the barrier ribs 21 are formed over the rear substrate 20 over which the address electrodes 22 are formed.

Phosphor layers 23 are formed on the surfaces of the lower dielectric layer 24 and the barrier ribs 21. Each barrier rib 21 has a longitudinal barrier rib 21a and a traverse barrier rib 21b formed in a closed type. The barrier rib 21 functions to partition discharge cells physically and prevent ultraviolet rays, which are generated by a discharge, and a visible ray from leaking to neighboring discharge cells.

The embodiment of the present invention may also be applied to not only the structure of the barrier ribs 21 shown in FIG. 1, but also various forms of structures of the barrier ribs 21. For example, the present embodiment may be applied to a differential type barrier rib structure in which the longitudinal barrier rib 21a and the traverse barrier rib 21b have different heights, a channel type barrier rib structure in which a channel, which can be used as an exhaust passage, is formed in at least one of the longitudinal barrier rib 21a and the traverse barrier rib 21b, a hollow type barrier rib structure in which a hollow is formed in at least one of the longitudinal barrier rib 21a and the traverse barrier rib 21b, and so on.

In the differential type barrier rib structure, the traverse barrier rib 21b may preferably have a higher height than the longitudinal barrier rib 21a. In the channel type barrier rib structure or the hollow type barrier rib structure, a channel or hollow may be preferably formed in the traverse barrier rib 21b.

Meanwhile, in the present embodiment, it has been described and shown that the red (R), green (G), and blue (B) discharge cells are arranged on the same line. However, they may be arranged in different forms. For example, the R, G, and B discharge cells may also have a delta type arrangement of a triangle. Alternatively, the discharge cells may be arranged in various forms, such as square, pentagon and hexagon.

Furthermore, the phosphor layer 23 is excited with ultraviolet rays generated during the discharge of a gas, thus generating a visible ray of one of R, G, and B. Discharge spaces between the front/rear substrates 10 and 20 and the barrier ribs 21 are injected with an inert mixed gas for a discharge, such as He+Xe, Ne+Xe or He+Ne+Xe.

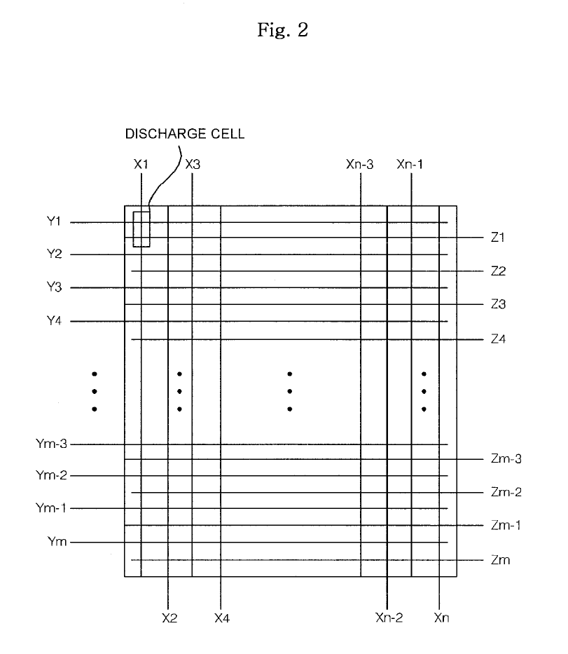

FIG. 2 is a view illustrating an embodiment of electrode arrangements of the PDP. It is preferred that a plurality of discharge cells constituting the PDP be arranged in a matrix form as illustrated in FIG. 2. The plurality of discharge cells are disposed at the intersections of scan electrode lines Y1 to Ym, sustain electrodes lines Z1 to Zm, and address electrodes lines X1 to Xn, respectively. The scan electrode lines Y1 to Ym may be driven sequentially or at the same time. The sustain electrode lines Z1 to Zm may be driven at the same time. The address electrode lines X1 to Xn may be driven with them being divided into even-numbered lines and odd-numbered lines, or driven sequentially.

The electrode arrangements shown in FIG. 2 are only an embodiment of electrode arrangements of the PDP according to the present invention. Therefore, the present invention is not limited to the electrode arrangements and the driving method of the PDP shown in FIG. 2. For example, the present invention may also be applied to a dual scan method of driving two of the scan electrode lines Y1 to Ym at the same time. Alternatively, the address electrode lines X1 to Xn may be driven with them being divided into upper and lower parts on the basis of the center of the PDP.

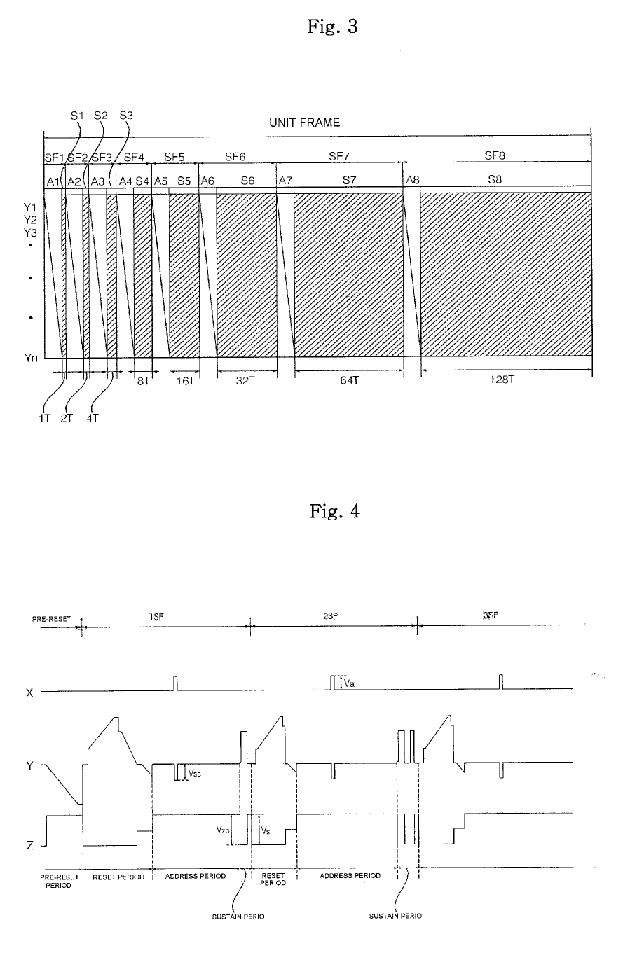

FIG. 3 is a timing diagram illustrating an embodiment of a method of time-dividing and driving the PDP by dividing one frame into a plurality of subfields. A unit frame may be divided into a predetermined number (for example, eight subfields SF1, . . . , SF8) in order to realize a time-divided gray level display. Each of the subfields SF1, . . . , SF8 is divided into a reset period (not shown), address periods A1, . . . , A8, and sustain periods S1, . . . , S8.

In accordance with an embodiment of the present invention, the reset period may be omitted in at least one of the plurality of subfields. For example, the reset period may exist only in the first subfield, or exist only in a subfield approximately between the first subfield and the entire subfields.

In each of the address periods A1, . . . , A8, a display data signal is applied to the address electrode X, and scan signals corresponding to the scan electrodes Y are sequentially applied to the address electrode X.

In each of the sustain periods S1, . . . , S8, a sustain pulse is alternately applied to the scan electrodes Y and the sustain electrodes Z. Accordingly, a sustain discharge is generated in discharge cells on which wall charges are formed in the address periods A1, . . . , A8.

The luminance of the PDP is proportional to the number of sustain discharge pulses within the sustain periods S1, . . . , S8, which is occupied in a unit frame. In the event that one frame to form 1 image is represented by eight subfields and 256 gray levels, different numbers of sustain pulses may be sequentially allocated to the respective subfields at a ratio of 1, 2, 4, 8, 16, 32, 64, and 128. For example, in order to obtain the luminance of 133 gray levels, a sustain discharge can be generated by addressing the cells during the subfield 1 period, the subfield 3 period, and the subfield 8 period.

The number of sustain discharges allocated to each subfield may be varied depending on the weight of a subfield according to an Automatic Power Control (APC) step. In other words, although an example in which one frame is divided into eight subfields has been described with reference to FIG. 3, the present invention is not limited to the above example, but the number of subfields to form one frame may be changed in various ways depending on design specifications. For example, the PDP may be driven by dividing one frame into eight or more subfields, such as 12 or 16 subfields.

Further, the number of sustain discharges allocated to each subfield may be changed in various ways in consideration of gamma characteristics or panel characteristics. For example, the degree of gray levels allocated to the subfield 4 may be lowered from 8 to 6, and the degree of gray levels allocated to the subfield 6 may be raised from 32 to 34.

FIG. 4 is a timing diagram illustrating an embodiment of driving signals for driving the PDP with respect to the one divided subfield.

Each subfield includes a pre-reset period where positive wall charges are formed on the scan electrodes Y and negative wall charges are formed on the sustain electrodes Z, a reset period where discharge cells of the entire screen are reset using wall charge distributions formed in the pre-reset period, an address period where discharge cells are selected, and a sustain period where the discharge of selected discharge cells is sustained.

The reset period includes a set-up period and a set-down period. In the set-up period, a ramp-up waveform is applied to the entire scan electrodes at the same time, so that a minute discharge occurs in the entire discharge cells and wall charges are generated accordingly. In the set-down period, a ramp-down waveform, which falls from a positive voltage lower than a peak voltage of the ramp-up waveform, is applied to the entire scan electrodes Y at the same time, so that an erase discharge occurs in the entire discharge cells. Accordingly, unnecessary charges are erased from the wall charges generated by the set-up discharge and spatial charges.

In the address period, a scan signal scan having a negative voltage Vsc is sequentially applied to the scan electrodes, and a data signal data having a positive voltage Va is applied to the address electrodes simultaneously with the scan signal. Thus, an address discharge is generated by a voltage difference between the scan signal scan and the data signal data and a wall voltage generated during the reset period, so that the cells are selected. On the other hand, during the set-down period and the address period, a signal to sustain a sustain voltage is applied to the sustain electrode.

In the sustain period, a sustain pulse having a sustain voltage Vs is alternately applied to the scan electrode and the sustain electrode, so that a sustain discharge is generated between the scan electrode and the sustain electrode in the form of a surface discharge.

The driving waveforms shown in FIG. 4 correspond to an embodiment of signals for driving the PDP according to the present invention, and the present invention is not limited to the waveforms shown in FIG. 4. For example, the pre-reset period may be omitted, the polarity and voltage levels of the driving signals shown in FIG. 4 may be changed, if appropriate, and an erase signal for erasing wall charges may be applied to the sustain electrode after the sustain discharge is completed. Alternatively, the present invention may also be applied to a single sustain driving method of generating a sustain discharge by applying the sustain signal to either the scan electrode Y or the sustain electrode Z.

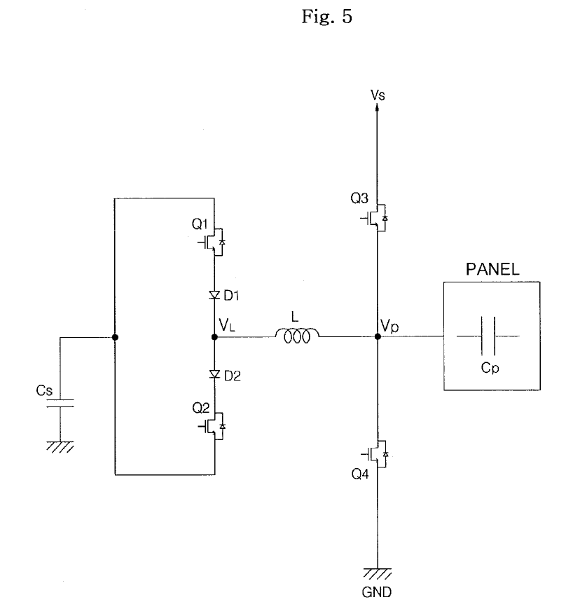

FIG. 5 is a circuit diagram illustrating a construction of an energy recovery circuit for supplying the sustain signal to the scan electrode or the sustain electrode of the PDP.

Referring to FIG. 5, the energy recovery circuit includes a source capacitor Cs, an inductor L, an energy supply switch Q1, an energy recovery switch Q2, a SUS_up switch Q3, and a SUS_down switch Q4.

The source capacitor Cs recovers energy from a panel Cp and stores recovered energy. The inductor L forms a resonant circuit together with the capacitance Cp of the PDP and the source capacitor Cs. The energy supply/recovery switches Q1 and Q2 are connected between the source capacitor Cs and the inductor L, and control the supply and recovery of energy, respectively. The source capacitor Cs recovers a voltage charged in the PDP at the time of a sustain discharge, stores the recovered voltage, and supplies the stored voltage to the PDP again when a sustain signal is supplied to the PDP.

The SUS_up switch Q3 is connected to a sustain voltage source Vs and is turned on to supply a sustain voltage to the PDP. The SUS_down switch Q4 is connected to a reference voltage source and is turned on to fall the voltage of the PDP to a reference voltage. As shown in FIG. 5, the reference voltage may be a ground voltage GND, and the reference voltage source to which the SUS_down switch Q4 is connected may be grounded.

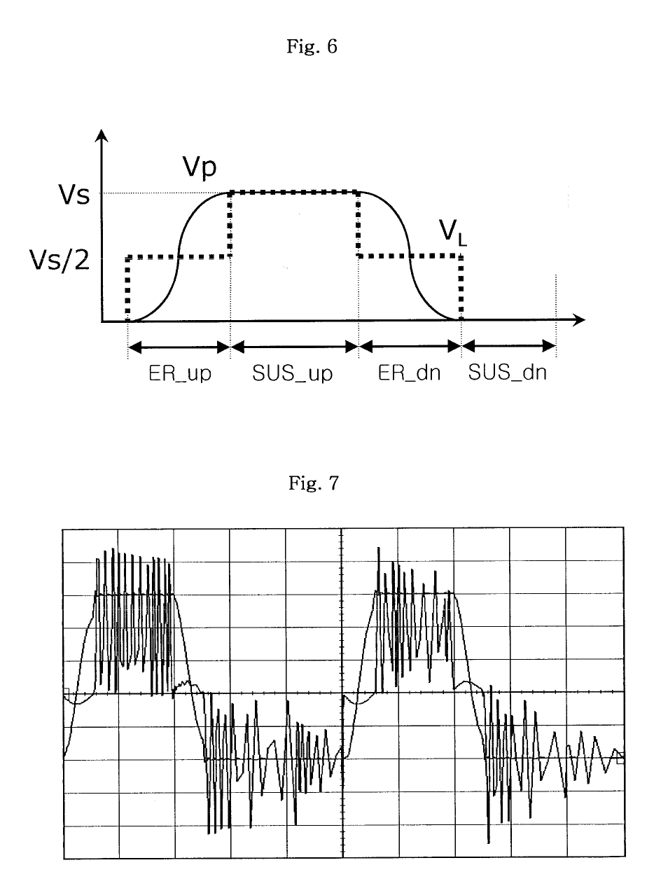

The operation of the energy recovery circuit will be described in more detail with reference to an embodiment of a waveform of the sustain signal shown in FIG. 6.

If power of the entire plasma display apparatus is turned on and a number of discharges are continuously generated in the PDP, a discharge current of the PDP is charged into the source capacitor Cs through the inductor L.

In an energy supply step ER_up, if the energy supply switch Q1 is turned on, the voltage charged into the source capacitor Cs is supplied to the PDP. Accordingly, the voltage of the sustain signal applied to the PDP gradually rises.

In a sustain voltage sustain step SUS_up, if the SUS_up switch Q3 is turned on, the sustain signal applied to the PDP sustains the sustain voltage Vs.

In an energy recovery step ER_dn, if the energy recovery switch Q2 is turned on, the energy charged into the PDP is recovered by the source capacitor Cs through the inductor L. Accordingly, the voltage of the sustain signal applied to the PDP gradually falls.

Thereafter, in a reference voltage sustain step SUS_dn, if the SUS_down switch Q4 is turned on, the voltage of the sustain signal applied to the PDP abruptly drops to the reference voltage (for example, the ground voltage) and is then kept.

In other words, in the energy supply step ER_up and the energy recovery step ER_dn, the source capacitor Cs, the capacitance Cp of the PDP, and the inductor L form a resonant circuit. This resonance enables the energy, charged into the source capacitor Cs, to be supplied to the PDP through the inductor L or the energy, charged into the PDP, to be recovered by the source capacitor Cs.

While the energy supply step ER_up to the reference voltage sustain step SUS_dn are repeated, the energy recovery circuit supplies the sustain signal to the PDP.

In the energy supply step ER_up and the energy recovery step ER_dn, a voltage VL (indicated by a dotted line) of one end, which is not connected to the PDP, of both ends of the inductor L is kept to Vs/2 as the energy supply/recovery switches Q1 and Q2 are turned on, as shown in FIG. 6.

On the other hands, as shown in FIG. 7, the voltage Vp applied to the PDP is kept to the sustain voltage Vs in the sustain voltage sustain period SUS_up, so that the voltage VL at the one end of the inductor L resonates toward the sustain voltage Vs at a high frequency.

At this time, a peak voltage higher than the sustain voltage Vs is generated at one end of the inductor L. Accordingly, an electromagnetic interference (EMI) problem and an unnecessary resonance phenomenon occur, and the inductor can be damaged.

Even in the reference voltage sustain period SUS_dn, the voltage Vp supplied to the PDP is kept to the reference voltage GND, and the voltage VL at one end of the inductor L resonates toward the reference voltage GND at a high frequency. Consequently, the above problems may occur.

Due to the above operation, the amount of a circulation current flowing through the energy recovery circuit can rise instantly, the occurrence of switching may increase, and energy efficiency may decrease.

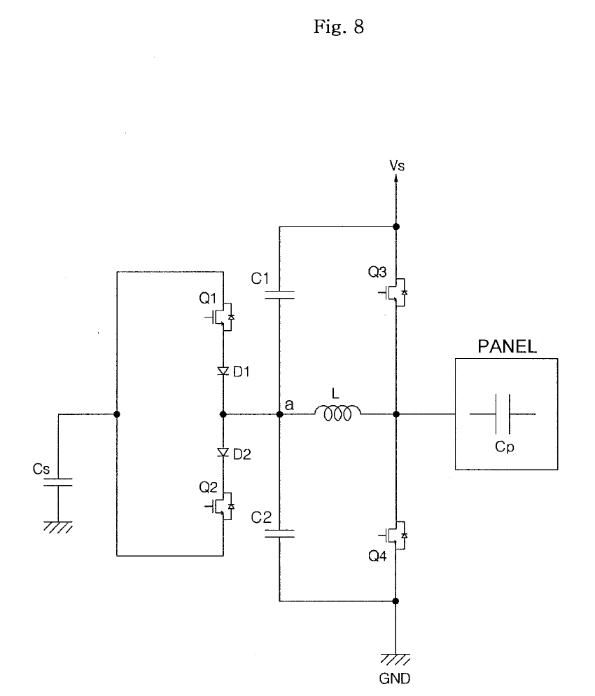

FIGS. 8 to 14 are circuit diagrams illustrating embodiments of a construction of the energy recovery circuit according to the present invention. In the energy recovery circuit according to the present invention, capacitors may be connected to one end of the inductor L, which constitutes a resonant circuit together with the source capacitor Cs and the capacitance Cp of the PDP.

Referring to FIG. 8, in order to prevent a voltage of one end “a” of the inductor L from resonating at a frequency higher than the sustain voltage Vs, a capacitor C1 may be connected between the one end “a”, which is not connected to the PDP, of both ends of the inductor L and the sustain voltage source Vs.

In order to prevent a voltage of the one end “a” of the inductor L from greatly resonating at a frequency lower than the reference voltage GND, a capacitor C2 may be connected between the one end “a” of the inductor and the reference voltage source GND.

That is, in the energy recovery circuit according to the present invention, the capacitor C1 is connected between the one end “a” of the inductor and the sustain voltage source Vs, so that the voltage of the one end “a” of the inductor L can be prevented from peaking to a voltage higher than the sustain voltage Vs (that is, a voltage supplied to the PDP) in the sustain voltage sustain step SUS_up.

Further, the capacitor C2 is connected between the one end “a” of the inductor and the reference voltage source GND, so that the voltage of the one end “a” of the inductor L can be prevented from peaking to a voltage lower than the reference voltage GND (that is, a voltage supplied to the PDP) in the reference voltage sustain step SUS_dn.

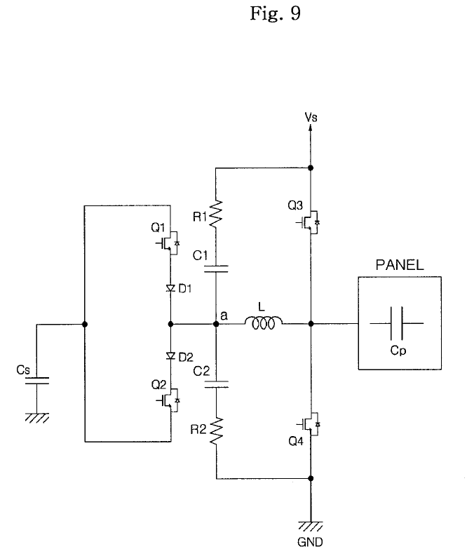

Referring to FIG. 9, capacitors C1 and C2 and resistors R1 and R2, which are connected in series, may be connected between the one end “a” of the inductor and the sustain voltage source Vs or between the one end “a” of the inductor and the reference voltage source GND.

If the capacitors C1 and C2 are connected between the one end “a” of the inductor and the voltage source Vs, GND as shown in FIG. 8, a high frequency component of a wide band, of the voltage of the one end “a” of the inductor, can be removed. On the other hand, if the capacitors C1 and C2 and the resistors R1 and R2 are connected in series between the one end “a” of the inductor and the voltage source Vs, GND as shown in FIG. 9, a specific frequency region component of the voltage of the one end “a” of the inductor can be removed by controlling capacitance of the capacitors C1 and C2 or a resistance value of the resistors R1 and R2.

It has been shown in FIGS. 8 and 9 that the capacitors C1 and C2, or the capacitors C1 and C2 and the resistors R1 and R2, which are connected in series, are connected between the one end “a” of the inductor and the voltage source Vs, GND. However, in the energy recovery circuit according to the present invention, other elements, which can prevent the voltage of the one end “a” of the inductor from vibrating and peaking higher than the sustain voltage Vs or the reference voltage GND, may be connected between the one end “a” of the inductor and the voltage source Vs, GND.

For example, a capacitor and am inductor CL connected in series may be connected between the one end “a” of the inductor and the voltage source Vs, GND, or a capacitor, a resistor, and an inductor RLC, which are connected in series, may be connected between the one end “a” of the inductor and the voltage source Vs, GND. Alternatively, in order to reduce a peak voltage applied to a device when a semiconductor device is turned off and switching loss, or prevent inverse bias secondary breakdown of a transistor, a snubber circuit (that is, a protection circuit) may be connected between the one end “a” of the inductor and the voltage source Vs, GND.

Alternatively, unlike FIGS. 8 and 9, the capacitors C1 and C2 may be connected between both ends of the inductor L or between the one end “a” of the inductor L and the source capacitor Cs.

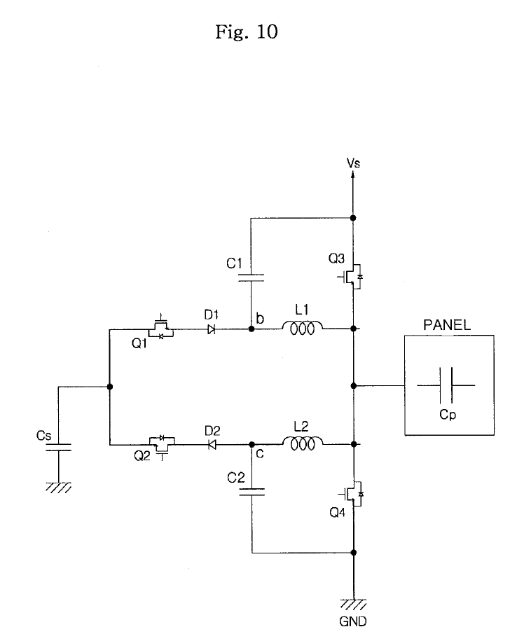

Referring to FIG. 10, the energy recovery circuit may include a first inductor L1 having one end b connected to an energy supply switch Q1, and a the second inductor L1 having one end c connected to an energy recovery switch Q2.

In this case, since the first capacitor C1 is connected between the one end b of the first inductor L1 and a sustain voltage source Vs, a voltage of the one end b of the first inductor L1 can be prevented from peaking higher than the sustain voltage Vs. Further, since the second capacitor C2 is connected between the one end c of the second inductor L2 and a reference voltage source GND, a voltage of the one end c of the second inductor L2 can be prevented from peaking lower than a reference voltage GND.

Alternatively, as described above, a capacitor and a resistor connected in series may be connected between the one end b of the first inductor L1 and the sustain voltage source Vs or the one end c of the second inductor L2 and the reference voltage source GND.

The energy recovery circuit constructed above according to the present invention can be used to supply the address electrode with not only a sustain signal, but also other driving signals such as a data signal.

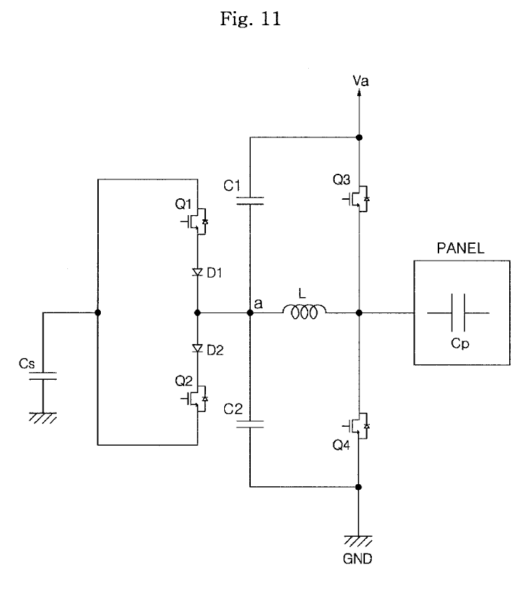

FIG. 11 is a circuit diagram illustrating an embodiment of a construction of an energy recovery circuit for supplying an address electrode with a data signal having the voltage Va. The same parts as those of the circuit shown in FIG. 11, which have been described with reference to FIGS. 5 to 10, will not be described.

Referring to FIG. 11, in the energy supply step ER_up and the energy recovery step ER_dn, the source capacitor Cs, the capacitance Cp of the PDP, and the inductor L form a resonant circuit. Such resonance enables energy, which has been charged into the source capacitor Cs, to be supplied to the address electrode of the PDP through the inductor L, or the energy, which has been charged into the address electrode of the PDP, to be recovered by the source capacitor Cs. Accordingly, energy efficiency for data signal supply can be improved.

Even in this case, the above problems, such as that a voltage of the one end “a” of the inductor L exceeds the data voltage Va and thus resonates at a frequency, or greatly resonates lower than the reference voltage GND, thereby distorting a data signal waveform, may occur.

However, if a capacitor C1 is connected between the one end “a” of the inductor L and the data voltage source Va as shown in FIG. 11, the voltage of the one end “a” of the inductor L can be prevented from peaking higher than the sustain voltage Vs (that is, a voltage supplied to the PDP) in the data voltage sustain step.

A capacitor C2 is also connected between the one end “a” of the inductor L and the reference voltage source GND. Thus, the voltage of the one end “a” of the inductor L can be prevented from peaking lower than the reference voltage GND (that is, a voltage supplied to the PDP) in the reference voltage sustain step.

As described above, a capacitor and a resistor connected in series may be connected between the one end “a” of the inductor L and the data voltage source Va or the reference voltage source GND, and the first and second inductors connected to the energy supply/recovery switches Q1 and Q2, respectively, may be included between the one end “a” of the inductor L and the data voltage source Va or the reference voltage source GND.

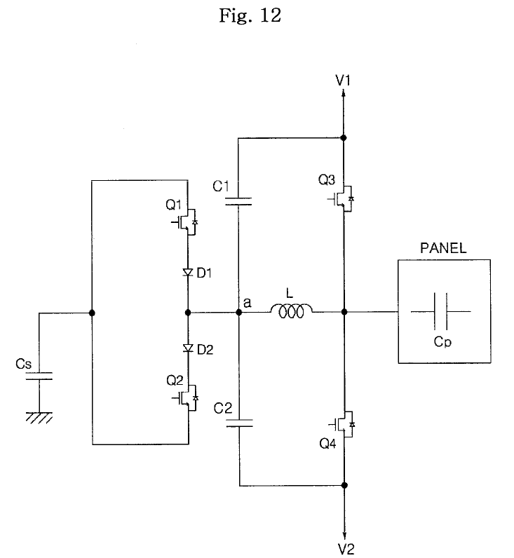

Referring to FIG. 12, the energy recovery circuit according to the present invention may include first and second voltage sources V1 and V2 having predetermined voltages, respectively, other than the sustain voltage source Vs, the data voltage source Va, and the reference voltage source GND.

Even in this case, in order to prevent the voltage of the one end “a” of the inductor L from greatly vibrating higher than the first voltage V1 or lower than the second voltage V2, the capacitors C1 and C2, and a capacitor and a resistor connected in series may be connected between the one end “a” of the inductor and the first voltage source V1 or the second voltage source V2.

Furthermore, the energy recovery circuit according to the present invention is not limited to the circuit construction and operation described with reference to FIGS. 5 to 12. In other words, in the energy recovery circuit for recovering and supplying energy using the resonant circuit constructed of the inductor, the capacitance Cp of the PDP, etc. and supplying a driving signal to the PDP, a capacitor, or a capacitor and a resistor that are connected in series may be connected between the one end “a” of the inductor and the voltage source. Accordingly, a voltage of one end of the inductor can be prevented from peaking.

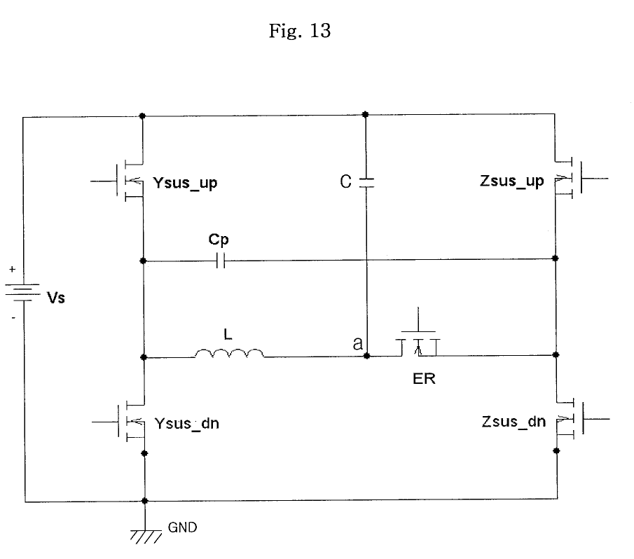

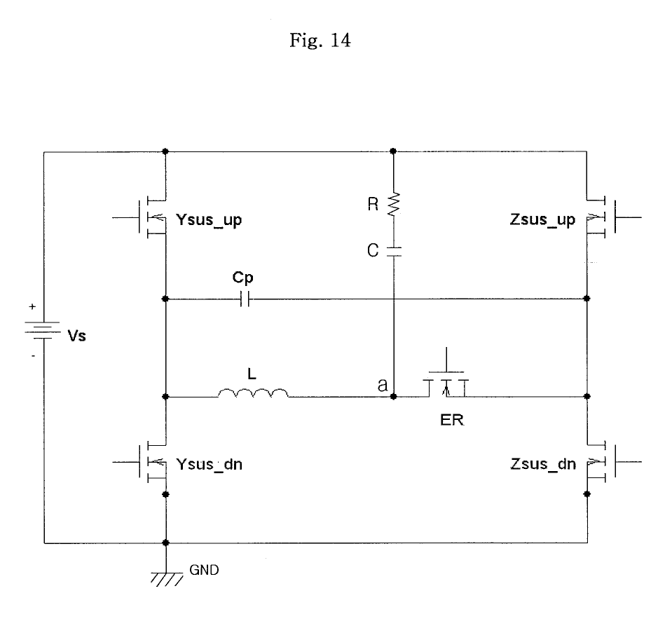

FIGS. 13 and 14 are circuit diagrams illustrating another embodiments of a construction of an energy recovery circuit according to the present invention.

As shown in FIGS. 13 and 14, even in the case of an energy recovery circuit having a construction different from the construction described with reference to FIGS. 5 to 12, a capacitor C, or a capacitor C and a resistor R that are connected in series may be connected between one end “a” of both ends of an inductor L for forming a resonant circuit, which is not connected to a panel, and a voltage source Vs.

In the above description, an example in which the energy recovery circuit according to the present invention is used for a plasma display apparatus has been described. However, the present invention is not limited to the above example, but the energy recovery circuit may be used to generate a driving signal supplied to several display panels, such as LCD and OLED, other than a PDP.

As described above, according to the present invention, in the event that a driving signal is to be supplied to a PDP using an energy recovery circuit, a capacitor is connected to one end of the inductor of the energy recovery circuit. Accordingly, distortion of a driving signal waveform supplied to a panel, which is caused by using a cheap element, can be prevented, damage to an inductor due to a voltage can be prevented, and stability of the energy recovery circuit can be improved.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display apparatus comprising a plasma display panel (PDP), and a driver for generating a driving signal for driving the PDP,
wherein the driver comprises:
a first capacitor for charging a voltage recovered from the PDP;
an inductor for forming a resonant circuit together with the first capacitor;
first and second switches, respectively having one end connected to the first capacitor and for controlling recovery and supply of energy between the first capacitor and the PDP;
first and second voltage sources for supplying a first voltage and a second voltage, respectively for generating the driving signal;
a second capacitor connected between one end of the inductor and the first voltage source; and
a third capacitor connected between one end of the inductor and the second voltage source,
wherein the second capacitor is connected between the other end of the first switch and the first voltage source, and the third capacitor is connected between the other end of the second switch and the second voltage source, and
the other end of the inductor is connected to the PDP.

2. The plasma display apparatus of claim 1, wherein the inductor comprises a first inductor connected between the first switch and the PDP and a second inductor connected between the second switch and the PDP, the second capacitor is connected between one end of the first inductor and the first voltage source, and the third capacitor is connected between one end of the second inductor and the second voltage source.

3. The plasma display apparatus of claim 1, wherein the driver comprises a third switch connected between the first voltage source and the PDP and a fourth switch connected between the second voltage source and the PDP, and
the second capacitor is connected between one end of the inductor and the third switch.

4. The plasma display apparatus of claim 3, wherein the third capacitor is connected between one end of the inductor and the fourth switch.

5. The plasma display apparatus of claim 3, wherein the inductor comprises a first inductor connected between the first switch and the PDP and a second inductor connected between the second switch and the PDP, the second capacitor is connected between one end of the first inductor and the first voltage source, and the third capacitor is connected between one end of the second inductor and the second voltage source.

6. The plasma display apparatus of claim 1, wherein the driver further comprises a resistor connected in series to the second capacitor.

7. The plasma display apparatus of claim 1, wherein the driver further comprises a third inductor connected in series to the second capacitor.

8. An energy recovery circuit for supplying a sustain signal to a PDP, the circuit comprising:
a first capacitor for charging a voltage recovered from the PDP;
an inductor for forming a resonant circuit together with the first capacitor;
first and second switches, respectively having one end connected to the first capacitor and for controlling recovery and supply of energy between the first capacitor and the PDP;
a sustain voltage source and a reference voltage source for supplying a sustain voltage and a reference voltage for generating the sustain signal, respectively;
a second capacitor connected between one end of the inductor and the sustain voltage source; and
a third capacitor connected between one end of the inductor and the reference voltage source,
wherein the second capacitor is connected between the other end of the first switch and the sustain voltage source, the third capacitor is connected between the other end of the second switch and the reference voltage source, and the other end of the inductor is connected to the PDP.

9. The energy recovery circuit of claim 8, further comprising:
a third switch connected between the sustain voltage source and the PDP and a fourth switch connected between the reference voltage source and the PDP,
wherein the second capacitor is connected between one end of the inductor and one of both ends of the third switch, which is not connected to the PDP, and the third capacitor is connected between one end of the inductor and one of both ends of the fourth switch, which is not connected to the PDP.

10. The energy recovery circuit of claim 8, wherein the inductor comprises a first inductor connected between the first switch and the PDP and a second inductor connected between the second switch and the PDP, the second capacitor is connected between one of both ends of the first inductor, which is not connected to the PDP, and the sustain voltage source, and the third capacitor is connected between one of both ends of the second inductor, which is not connected to the PDP, and the reference voltage source.

11. The energy recovery circuit of claim 8, further comprising a resistor connected in series to at least one of the second and third capacitors.
